(19) United States
(12) Patent Application Publication
(10) Pub. No.: US 2013/0205625 A1
(43) Pub. Date: Aug. 15, 2013

(54) Twirling Sports Banner Apparatus

(71) Applicant: Stanley F. Pilok, Fogelsville, PA (US)

(72) Inventor: Stanley F. Pilok, Fogelsville, PA (US)

(21) Appl. No.: 13/369,374

(22) Filed: Feb. 9, 2012

(51) Int. Cl. G09F 17/00

(52) U.S. Cl. 40/218

(57) ABSTRACT

A sports banner twirling device for retaining a sports banner or towel with a grasping mechanism located at the end of an extension arm clipped to a spindle projecting upward and axially aligned along the longitudinal axis of the handle held by the user. The extension arm can be articulating or non-articulating and houses at its distal end a sports banner grasping mechanism for receiving and retaining a portion of the sports banner for twirling until manually removed. Sports team indicia can also be mounted to the side faces of said handle.

### BACKGROUND OF THE INVENTION

Banner waving at sporting events is considered to be an ancient rite where people attending sporting events cheered on the favored sports person or team by waving colored flags or banners in support of the athletes. In more recent times, professional sports teams have renewed interests in banners being waved by sports fans attending the contest in the form of rectangular banners carrying the team logo or the team colors. This recent advent of bringing back and waving the banners had its start with the Pittsburgh Steelers football team in 1975 with the “Terrible Towel” that was provided to fans for cheering on their team while in the stadium. The “towels” have now become prominent at a great many more sporting events and have migrated to other sports contests as well as football.

The rally towels or banners have become a commonplace fan requirement such as team clothing, hats with team logos, etc. However, one of the problems with the rally towel is for the fan to initially get the towel to twirl and then to retain the towel in a twirling motion. Manually twirling a towel by using one's hand and arm is a difficult maneuver to maintain without injury or tiring of the arm. Also, the towel, due to the type of spinning or twirling by the individual fan, may fold over on itself or curl over itself as the towel is held in only one corner.

In order to alleviate the tedium and difficulty of the repetitive motion, and to spread the towel open, devices have been conceived that purport to permit an easier motion and unfurl the towel.

U.S. Pat. No. 4,913,940 [Pratt] provides a disk having a clip for retaining one corner of the rally towel. However, the ability to hold the disk between one's thumb and forefinger while attempting to spin or twirl the towel is difficult and tiring. Although the clip rotates freely about an axle or pin extending perpendicularly outward from the circumference of the disk, the small repeating circular motion of the wrist and the inward clamping of the thumb and forefinger holding onto the disk is tiresome and can result in injury to the wrist if continued for long periods.

Another concept is put forward in U.S. Patent Application Publication US 2011/0028065 A1 [Arcovio] that provides a handgrip or handle beneath a capture mechanism for retaining a rally towel attached to the handle. In this conception the rally towel has a hole and grommet inserted into one corner and that corner is attached to the handle for free rotation about the axis of the handle. This device is easier to manipulate and may not cause the same physical fatigue as the earlier disk. However, the attachment element is cumbersome and the rally towel must either be manufactured with the hole and protective grommet or be converted to accept the grommet otherwise operation becomes relatively impossible. Further, the clamping mechanism appears to be press-fitted that will tend to open and let go if the twirling activity continues for a longer period of time without resetting the clamping mechanism to its required retention position.

Still another concept is described in U.S. Patent Application Publication US 2011/0173851 A1 [Cohen] that also provides a handle beneath a capture mechanism for retaining the rally towel attached to the handle. In this case, the handle suffers that same deficiency as the disk in that the handle is quite small and difficult to grasp with one's hand. Further, the capture mechanism also requires the towel to be perforated in a corner, a grommet-like ring placed around the opening, and the combination attached to the handle spinner. The clamping mechanism also appears to be press fitted and will tend to loosen after repeated twirling motions. As in the case of the disk as a holding point, the small handle with the repeating circular motion of the wrist and the inward clamping of the hand around a relatively small diameter handle is a tiresome activity and can result in injury to the wrist if continued for long periods.

Another concept is a do-it-yourself twirling concept made available through an Internet purchase as the Towelspinner™. This device appears to be a round noise maker with a small handle, similar to those used on New Year's Eve, to which is attached a clip for holding the towel at a point midway along one side of the towel after a cooperating hole is placed in the towel. As shown, the handle is only capable of being grasped by two fingers and the thumb which creates a difficult grasping position to be retained for any lengthy period of time. Further, the self-created hole in the towel may fray over time with use without peripheral support in the form of a grommet or similar reinforcing means. This concept suffers from the same deficiencies as the others and is not believed to create a solution to the problem of retaining the rally towel unfurled and in a twirling position while in use.

It is, therefore, one object of the present invention to provide a twirling device that is easy to grasp and to continue to hold during use without fatigue to the user. It is a further object to not require any alteration or modification to the rally towel or banner but to merely provide a clip for easy attachment and detachment from the handle.

It is also an object of the present invention to provide both ease of axial spinning about the transverse axis of the handle and, at the same time, to permit the rally towel to be twirled at any outward angle rather than be limited to a 90° fixed angle of rotation. It is a further object to permit the rally towel to be easily detached from the handle for storage and the handle clip to be folded away against the handle for easier carrying and storage.

It is a still further object of the present invention to provide a hand grip that configures to the user's hand such that all of the fingers and thumb easily are capable of grasping the handle in a comfortable arrangement. It is yet a further object to provide one or more places on the handle for sports team regalia such as team logos in the team colors. It is also an object of the present invention to provide a handle insert in the form of a bottle opener for use in a “tailgating” setting. Other objects will appear hereinafter.

### SUMMARY OF THE INVENTION

The sports banner or towel twirling device is comprised of a handle for ease of gripping by a user. The handle has a capped spindle mounted at its top end that is axially aligned with its longitudinal axis to which an articulating arm is attached by a spring clip. The articulating arm is comprised of the proximal spring clip, a distal sports banner or towel grasping means, and an articulating joint therebetween. The articulating joint changes the motion of the arm from perpendicular to the axis of the spindle to a range of angular positions approaching parallelity with the axis of the spindle. The grasping means includes a hook-like clip with a shaft and opposing arm with a sports banner or towel receiving space therebetween. In the receiving space and located on both the shaft and arm of the hook-like clip are a plurality of teeth with opposing cooperating recess for capturing the portion of the sports banner or towel inserted therein and retaining the banner or towel in that position until manually removed. The spring clip is curved to match the circumference of the spindle so as to provide an unimpeded rotational motion of the articulating arm about the spindle.

Additionally, the handle has opposing face recesses for containing sports team indicia and may contain a bottle opener at the end farthest from the spindle. The twirling apparatus may be produced in sports team or league colors and is made from polymer or plastic solids.

A second embodiment of the sports banner or towel twirling apparatus has a non-articulating arm and a differently configure grasping means. The second embodiment has the same handle and spindle relationship, component features and functions. The non-articulating arm connects to the spindle mounted at the top of the handle by a similar spring clip that is dimensioned and curved to match the circumference of the spindle to provide for unimpeded rotational motion. The grasping means includes a first larger opening for insertion of a portion of the banner or towel, e.g., a corner, and a smaller distally tapering opening having a series of teeth along each sidewall for grasping the banner or towel therebetween. The opposing series of teeth will retain the sports banner or towel inserted therein until manually removed.

The sports banner or towel twirling device is easily grasped by the user and the twirling motion is initiated and continued easily by a flick of the wrist and a continuing swirling motion of the wrist and hand. The banner or towel tends to unfurl as the rotational motion is continued and will not unintentionally wrap around the users hand or arm as the arm of the twirling device moves the towel away from immediate contact with the user.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is an isometric view of the twirling handle and associated sports banner of a first embodiment of the invention.

FIG. 2 is a partial cross-sectional top view of the first embodiment of the twirling handle and sports banner attachment of the present invention.

FIG. 3 is a top plan view of the first embodiment of the present invention showing the rotation of the sports banner attachment element rotating about the axis of the twirling handle.

FIG. 4 is a side plan view of the first embodiment of the present invention showing the rotation of the sports banner attachment element rotating about the axis of the twirling handle and the vertical angular movement capability of the attachment element extension clip.

FIG. 5 is another side plan view of the first embodiment of the present invention showing the sports banner attachment element and the attachment element extension clip at rest with a bottle opener element inserted into the twirling handle.

FIG. 6 is a side plan view of a second embodiment of the present invention showing the sports banner attachment element attached to the twirling handle.

FIG. 7 is a top plan view of the second embodiment of the present invention showing the sports banner attachment element attached to the twirling handle.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

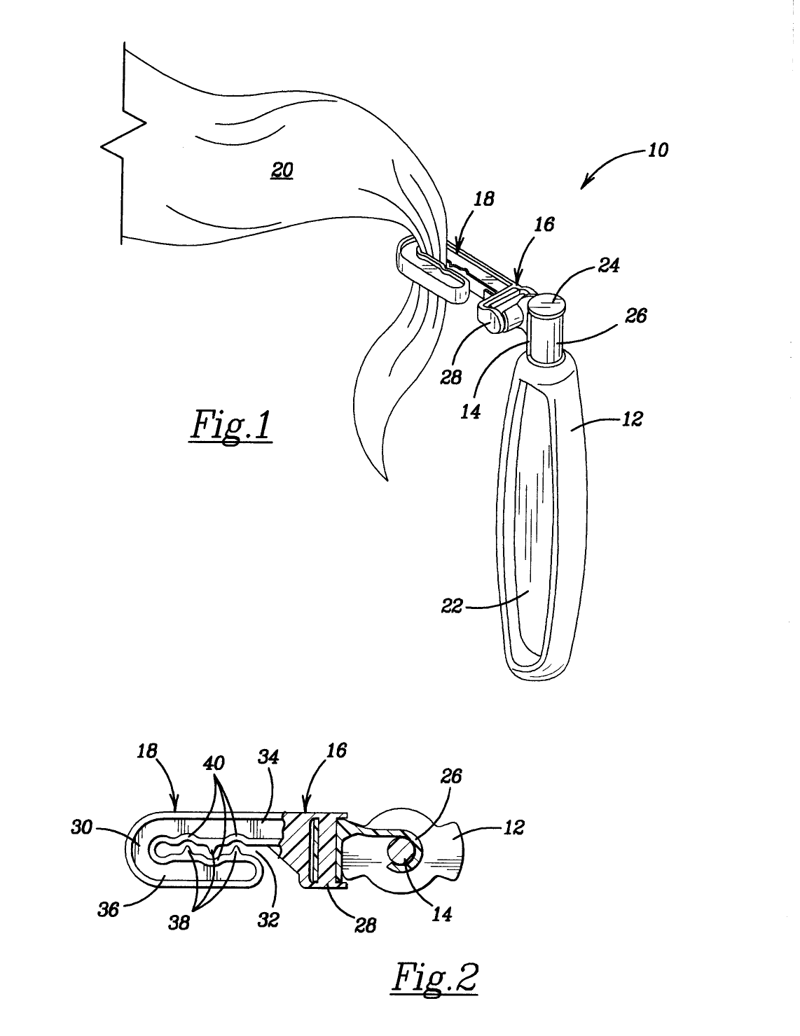

Referring now to the drawings in detail, where like numerals refer to like parts or elements, there is shown in FIG. 1 the hand-held twirling apparatus 10 of the present invention.

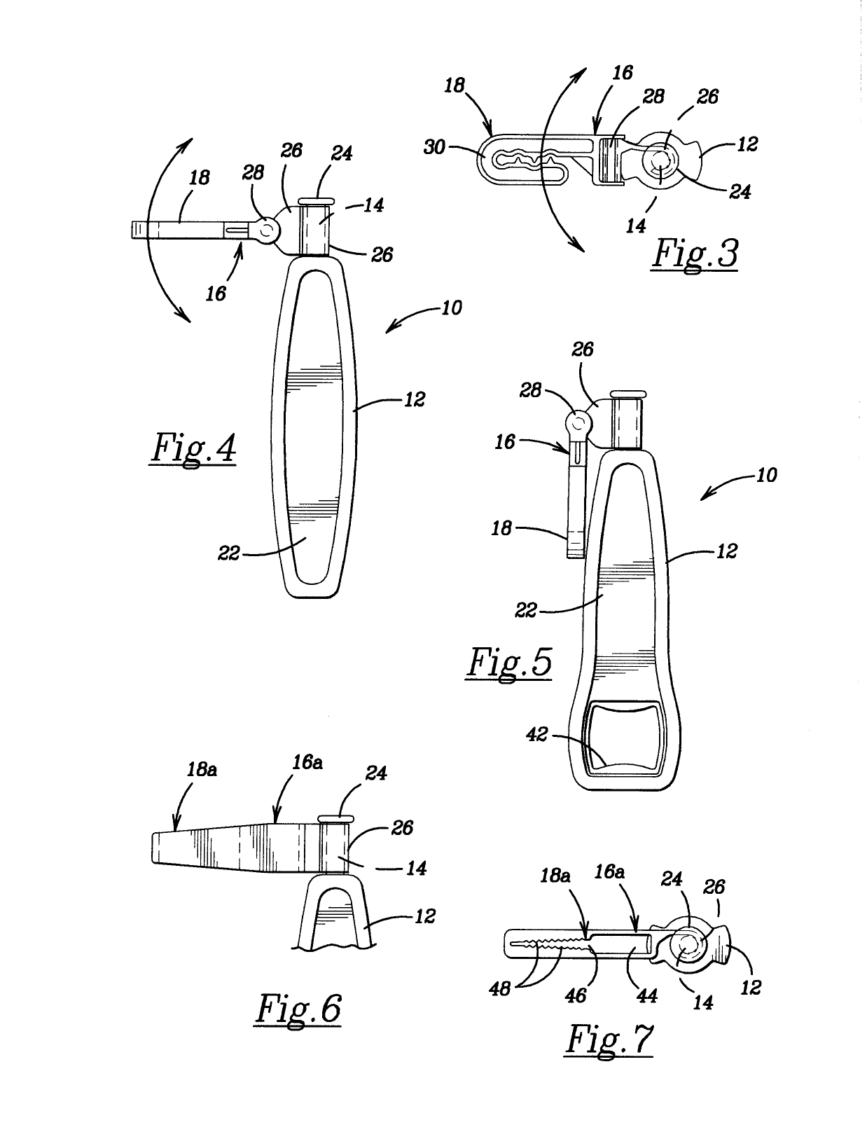

The twirling apparatus 10 is composed of a handle 12, a spindle 14, and an articulating arm 16 that has at its distal end a grasping mechanism 18 for holding the rally towel or banner 20 in place at the end of the arm 16. The handle 12 has a length sufficient for the complete gripping by the hand of a user having a normal grasping force. The handle may be of any form, or may have a hollowed out portion 22 to house and retain sports team regalia in the form of logos, team names, team colors and the like. At the top of the handle 12 is the spindle 14 that is aligned along the longitudinal axis of the handle 12. The spindle 14 has an enlarged section at its distal or topmost end in the form of a cap 24. This cap 24 is present to retain the spring clip 26 of the articulating arm 16 in its position around the spindle such that the clip 26 cannot fly off the end of the spindle 14 when the twirling apparatus 10 is in use. The spring clip 26 is sized to match the circumferential dimension of the spindle 14 such that the curvature of the clip 26 radially expands slightly as it is snap fitted into position around the spindle 14. The curved surfaces of the spindle 14 and the spring clip 26 cooperate to permit the free spinning of the clip 26, and thus the arm 16, around the spindle 14. See, FIG. 3 and further description below.

At a distance along the arm 16 sufficient in length to extend beyond the widest dimension of the handle 12 an articulating joint 28 is attached to the distal end of the spring clip 26. The articulating joint 28 permits the clip 26 to remain in a perpendicular position to the spindle 14 while the remainder of the arm 16 can be extended at the same angle, or any upward or downward angle for a full angular range of 180°. Referring to FIG. 4, one can view the full range of angular motion (shown by the arrow) by the grasping mechanism 18 extending beyond the articulating joint 28. As shown in FIG. 5, the grasping mechanism 18 is in a folded fully downward position lying against the handle 12 for ease of carrying and storage.

The distal end of the arm 16 carries the grasping mechanism 18 for grabbing onto and retaining the banner or “towel” in position in the twirling apparatus 10. The grasping mechanism 18 is composed of a hook-like clip 30 having a banner receiving opening 32 between the shaft 34 and opposing arm 36 of the hook 30. On the internal facing surfaces of the shaft 34 and arm 36 of the hook 30 are a series of opposing teeth 38 for gripping the fabric of the banner or towel 20 therebetween. Directly opposite each of the teeth 38 is a tooth receiving indentation 40 to better grip and hold the banner or towel 20. As shown in FIG. 1, the teeth 38 grip a corner of the banner or towel 20 between them so that the banner 20 remains firmly gripped by the hook-like clip 30 when the apparatus 10 is being twirled or is at rest. The banner or towel 20 must be manually removed from the hook-like clip 30 by slightly spreading the arm 36 away from the shaft 34 and sliding the banner or towel 20 over and away from the teeth 38 and out of the opening 32.

Referring now to FIG. 3, the range of rotational motion of the articulating arm 16 about the spindle 14 is shown by the arrow. The articulating arm 16 is capable of a complete 360° rotation about the spindle 14 without impediment. With the banner or towel 20 firmly gripped in the grasping mechanism 18 located at the distal end of the arm 16, the towel 20 acts as a weight to raise the arm outward and upward from the handle 12 as the twirling motion is initiated, and as it continues. Regardless of the angle of the handle to the ground, the articulating arm 16 provides an outward extension so that the banner or towel 20 will not wrap around the handle 12, or the hand or arm of the user. Further, the banner or towel 20 can unfurl away from the hand or small gripping means of twirling assistance devices and the indicia on the banner 20 can be seen as the twirling motion continues.

An additional feature that may be added to the twirling apparatus 10 is a bottle opener 42 that can be positioned in the base of the handle 12 as shown in FIG. 5. The shape of the handle 12 is slightly altered to accommodate the bottle opener 42 creating a slightly larger base than in the other examples. The slightly larger base does not affect the ability of the user to grasp the apparatus 10.

An alternative embodiment of the twirling apparatus 10 substitutes a non-articulating arm 16a attached to the spindle 14 atop the handle 12 instead of the articulating arm 16 described above. Referring to FIGS. 6 and 7, the non-articulating arm 16a has a spring clip 26 for fitting around the spindle 14 with similar cooperating curvature for a secure fit. The cap 24 prevents the non-articulating arm 16a from flying off the spindle 14 as described above. The cooperation of the spring clip 26 snap-fitted around the spindle 14 provides an almost frictionless capability to freely rotate without impediment.

At the distal end of the non-articulating arm 16a is a different grasping mechanism 18a composed of an aperture or banner receiving opening 44 adjacent the spring clip 26 and extending outward approximately half the distance of the non-articulating arm 16a for receiving a corner of the banner of towel 20. One corner of the banner or towel 20 is inserted into the banner receiving opening 44 located approximately midway along the non-articulating arm 16a. Once positioned within the receiving opening 44, the corner portion of the sports banner or towel 20 is slid away from the handle end of the non-articulating arm 16a and into a distally tapering opening 46 located between opposing series of teeth 48 arrayed along both sidewalls of the tapered opening 46. Once tightly inserted between the opposing series of teeth 48, the banner or towel 20 is retained therebetween until manually removed.

The non-articulating arm 16a is also capable of a complete 360° rotation about the spindle 14 without impediment. With the banner or towel 20 firmly gripped in the grasping mechanism 18a located at the distal end of the arm 16a, the non-articulating arm 16a provides an outward extension so that the banner or towel 20 will not wrap around the handle 12, or the hand or arm of the user. Further, and as described above, the banner or towel 20 can unfurl away from the hand or small gripping means of twirling assistance devices and the indicia on the banner 20 can be seen as the twirling motion continues.

The sports banner twirling apparatus can be manufactured from a variety of plastic or polymer solids by a process known as blow molding. Each of the component parts are dimensionally sized to cooperate and function with the other parts. The twirling apparatus can be manufactured in sports team colors, sports league colors, or any single or combination of colors of team indicia. Additionally, a sports team name or nickname can be molded into the handle along its outer portions or in the recess 22.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. An apparatus for twirling a sports banner comprising:
a handle providing sufficient space for gripping by a user;
a spindle mounted at one end of the handle and with its axis oriented along the longitudinal axis of said handle and a top cap of greater diameter than said spindle;
an articulating arm including a spring clip at its proximal end, a grasping means at its distal end, and an articulating joint therebetween, capable of mounting to said spindle by said spring clip;
said spring clip having a curvature matching the curved circumference of the spindle for unimpeded rotational motion, and being retained in position around said spindle once snapped in place by said spindle top cap;
said articulating joint capable of motion in a perpendicular direction to the rotation of the arm about said spindle; and,
said grasping means including a hook-like clip having an opening between the shaft and opposing arm of said hook-like clip for receiving and retaining a portion of said sports banner, whereby said user grips the handle once said sports banner is positioned and retained in said hook-like clip and twirls said sports banner.

2. The apparatus of claim 1, wherein said grasping means further comprising a plurality of opposing teeth located on each of said shaft and said arm with cooperating recesses directly opposite each of said teeth for capturing said portion of said sports banner therebetween.

3. The apparatus of claim 1, wherein said handle has one or more recessed faces for mounting sports team indicia therein.

4. The apparatus of claim 1, wherein said handle has a bottle opener housed within its lower portion at the end farthest from said spindle.

5. An apparatus for twirling a sports banner comprising:
a handle providing sufficient space for gripping by a user;
a spindle mounted at one end of the handle and with its axis oriented along the longitudinal axis of said handle and a top cap of greater diameter than said spindle;
a non-articulating arm including a spring clip at its proximal end and a grasping means at its distal end, capable of mounting to said spindle by said spring clip;
said spring clip having a curvature matching the curved circumference of the spindle for unimpeded rotational motion, and being retained in position around said spindle once snapped in place by said spindle top cap; and, said grasping means including a tapered opening for receiving and retaining a portion of said sports banner,
whereby said user grips the handle once said sports banner is positioned and retained in said tapered opening and twirls said sports banner.

6. The apparatus of claim 5, wherein said grasping means further comprising a first non-tapering portion of said tapered opening between sidewalls of said non-articulating arm for receiving a portion of said sports banner therein and a second tapering portion of said tapered opening distally located to said first portion with said second tapering portion containing a series of opposing teeth located on each sidewall for capturing said portion of said sports banner therebetween.

7. The apparatus of claim 5, wherein said handle has one or more recessed faces for mounting sports team indicia therein.

8. The apparatus of claim 5, wherein said handle has a bottle opener housed within its lower portion at the end farthest from said spindle.

9. A sports banner twirling device comprising:
a sports banner with a sports team indicia thereon;
a handle providing sufficient space for gripping by a user;
a spindle mounted at one end of the handle and with its axis oriented along the longitudinal axis of said handle and a top cap of greater diameter than said spindle;
an extension arm including a spring clip at its proximal end and a grasping means at its distal end, capable of mounting to said spindle by said spring clip;
said spring clip having a curvature matching the curved circumference of the spindle for unimpeded rotational motion, and being retained in position around said spindle once snapped in place by said spindle top cap; and,
said grasping means having an opening for receiving and retaining a portion of a sports banner therebetween.

10. The apparatus of claim 9, wherein said extension arm further comprises an articulating joint between said spring clip and said grasping means, said articulating joint capable of motion in a perpendicular direction to the rotation of the extension arm about said spindle.

11. The apparatus of claim 9, wherein said grasping means further comprising a hook-like clip with said opening for receiving said portion of said sports banner between the shaft and opposing arm of said hook-like clip and a plurality of opposing teeth located on each of said shaft and said arm with cooperating recesses directly opposite each of said teeth for capturing said portion of said sports banner therebetween.

12. The apparatus of claim 9, wherein said grasping means further comprising a first non-tapering portion of said opening located between sidewalls of said extension arm for receiving a portion of said sports banner therein and a second tapering portion of said opening distally located to said first portion with said second tapering portion containing a series of opposing teeth located on each sidewall for capturing said portion of said sports banner therebetween.

13. The apparatus of claim 9, wherein said handle has one or more recessed faces for mounting sports team indicia therein.

14. The apparatus of claim 9, wherein said handle has a bottle opener housed within its lower portion at the end farthest from said spindle.
